(19) United States
(12) Patent Application Publication
(10) Pub. No.: US 2010/0170577 A1
(43) Pub. Date: Jul. 8, 2010

(54) SEPARABLE FAUCET USING PLASTIC CONTROL VALVE

(75) Inventors: Boxiou LIU, Taichung County (TW); Yueping XIAO, Taichung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: GLOBE UNION INDUSTRIAL CORP.

(21) Appl. No.: 12/348,468

(22) Filed: Jan. 5, 2009

(51) Int. Cl. F16K 21/00; F16K 31/44

(52) U.S. Cl. 137/315.01; 251/231

(57) ABSTRACT

The separable faucet using a plastic control valve mainly includes two control bodies, an outlet assembly and a three-way pipe assembly. The control valve disposed in each of the control bodies for connecting an inlet pipe and an outlet pipe has joint holes corresponding to the inlet and outlet pipes. A sealing piece is sleeved on each of the joint sections of the inlet and outlet pipes to keep sealing between the joint section and the joint hole. A stop sheet disposed at the control valve is stopped at a stop face of the joint, fixing the joint reliably in the joint hole. Two ends of a soft plastic inner pipe disposed in a metal shell body of the outlet assembly are connected to a spout piece and a connecting pipe respectively. The three-way pipe assembly is connected to the connecting pipe and outlet pipes of the two control bodies.

### BACKGROUND OF THE INVENTION

1. Field of Invention

The present invention relates to a technical field of joints for a water supply pipeline, and in particular, to a separable faucet using a plastic control valve that ensures a combination effect of a plastic pipeline.

2. Related Art

Components such as a body and water outlet of a conventional faucet are usually made of copper or castings, etc. The manufacturing cost is high, and because a contact area between copper or other metal castings and water is relatively large, the water may contain toxic substances such as heavy metals, for example, lead. Thus, in America and some European countries, strict requirements start to be imposed on lead content in sanitary products. Therefore, it is an urgent task for manufacturers of sanitary products to decrease lead content in their products to meet European and American standards.

As such, persons in this field have developed a structure of mounting soft pipes in a faucet to decrease a contact area between water and copper or metal components, for example, U.S. Pat. No. 7,415,991, in which a chamber is formed inside a faucet made of metal for accommodating a tube. Two ends of the tube are respectively connected to an inlet coupling and an outlet coupling. The tube, the inlet coupling, and the outlet coupling are made of non-metallic materials. In such a way, all components in contact with water are made of the non-metallic materials so as to meet specifications with regard to water safety.

However, the technology disclosed in the above patent is only applied to an outlet faucet. As the outlet faucet is usually disposed at a downstream side of a water volume control valve, the outlet faucet bears a relatively lower water pressure so that fixation and leak proof may be easily achieved. However, if all components such as the water volume control valve and the pipeline joints are changed into plastic material products, it is quite a challenge to the conventional screw thread securing and leak-proof technology in terms of fixing and leak-proof.

As the conventional screw thread securing and leak-proof technology is applied to metal components that have a fine strength and are not easy to deform, the sealing effect may be achieved by applying a locking force on a leak-proof tape between the metal screw thread and screw hole by winding the leak-proof tape on the screw-tooth of the joint and then securing the screw thread of the joint into the screw hole of the water volume control valve.

However, if both the water volume control valve and the joint are made of plastic components instead, because the plastic material has a low strength and tends to deform by forces, and the precision and fitness between the plastic screw thread and screw hole is not good, it is difficult to control the force for urging the leak-proof tape. When the urging force is too small, it might be hard to achieve the sealing effect, and when the urging force is too great, the screw thread may be easily deformed or damaged.

Further, the plastic screw thread and screw hole have a low strength. In areas where the water pressure is high, the water hammer effect generated when opening or closing the water volume control valve may cause great changes in pressure, which will result in a great pulling force to the pipeline, and thus, the screw thread of the plastic joint looses from the screw hole.

Also, it is inconvenient to lock the screw thread of each pipeline joint into the screw hole. As a space at the bottom of the water volume control valve is quite small, in assembly, it might take a long time to tighten each joint by reaching a wrench from aside into a small space. Also the water volume control valve usually has to be connected to two joints to supply cold and hot water respectively, and sometimes another outlet pipe joint might be connected. Therefore, the tightening action must be performed for twice of three times, and in general, such an assembly method is relatively time-consuming and troublesome.

Moreover, the tube is usually made of a soft material having fine ductility. Thus, joints between the tube and the inlet coupling or the outlet coupling tend to loose or leak due to changes of water pressure, and therefore further improvement is needed.

### SUMMARY OF THE INVENTION

Accordingly, the present invention is directed to a separable faucet using a plastic control valve, which is capable of effectively counteract water pressure changes to ensure tight combination of plastic components.

To achieve the above objectives, the plastic control valve of the present invention is formed of a control valve, a joint, and a stop sheet.

The control valve is made of a plastic material and connected to an inlet pipe and an outlet pipe for controlling a water volume of the outlet pipe. The control valve at least has a joint hole corresponding to the inlet pipe and a joint hole corresponding to the outlet pipe, respectively. Each joint hole extends out of the control valve from inside. Each joint is connected to the inlet pipe or the outlet pipe, respectively. The joint has a joint section with a round cross-section corresponding to the joint hole, and one or more sealing pieces are sleeved on the joint section to keep a sealing between the joint section and the joint hole. One end of joint abutting the pipe body has a stop face. The stop sheet is fixed on a face of the control valve having the joint holes. The stop sheet has notches respectively corresponding to the inlet pipe and the outlet pipe. Each of the notches is used for only the inlet pipe or the outlet pipe to pass through, so that when the stop sheet is fixed at the control valve, the stop sheet may be stopped at the stop face of the joints, and fixes the joints in the joint holes.

Preferably, the control valve is disposed in a metal base. One end of the control valve away from the inlet pipe and the outlet pipe is connected to a handle.

Preferably, the plastic control valve is implemented in the separable faucet. The separable faucet is formed of two control bodies, an outlet assembly, and a three-way pipe assembly.

Each of the control bodies has a base respectively. A plastic control valve is disposed in the base. The control valve is connected to an inlet pipe and an outlet pipe respectively, and the control valve is coupled to a handle for adjusting a water volume.

The outlet assembly has a hollow shell body. The shell body is made of a metal material. A soft plastic inner pipe is disposed in the shell body. One end of the plastic inner pipe is connected to a spout piece. An engaging section extends from one end of spout piece abutting the plastic inner pipe. An outer edge of the engaging section has a plurality of collar parts in the shape of a barb. An outside diameter of each of the collar parts is slightly greater than an inside diameter of the plastic inner pipe. A metal cover is covered on an outer edge of one end of the plastic inner pipe abutting the engaging section, and an other end of the plastic inner pipe is then connected to a connecting pipe. The connecting pipe is made of a plastic material. A joint section extends from one end of the connecting pipe abutting the plastic inner pipe. A front end of the joint section has a cone part, and the joint section and the plastic inner pipe is in a tight fitting. A metal cap covers an outer edge of one end of the plastic inner pipe abutting the joint section. One end of the metal cap has an internal thread part. The connecting pipe is disposed with an external thread part correspondingly. The metal cap has a minor diameter part corresponding to the cone part of the joint section, so that the plastic inner pipe is urged against the joint section and cone part tightly by the minor diameter part. Both of the spout piece and the connecting pipe protrude from the shell body.

The three-way pipe assembly is made of a plastic material, and is connected to the connecting pipe and outlet pipes of the two control bodies respectively.

In such a manner, in the control valve of the present invention, the stop sheet stops and fixes the joint of the inlet pipe in the joint hole, while the sealing pieces of the joint may keep the sealing between the joint section and the joint hole, ensuring that problems such as loosening or leakage will not occur when the water pressure changes.

The stop sheet is secured at the control valve with the bolt, which may fix the joint of the inlet pipe. In addition, a screwdriver for spinning the bolt may easily reach into a small space at the bottom of the control valve to perform the assembly, so as to facilitate the assembly.

Moreover, between the plastic inner pipe and the spout piece of the present invention, water pressure changes may be counteracted through the limit of the metal cover to ensure the tight combination between the plastic inner pipe and the spout piece. Further, between the plastic inner pipe and the connecting pipe, the plastic inner pipe is urged against the joint section and the cone part tightly by the minor diameter part of the metal cap, so as to counteract the water pressure changes, and ensure a tight combination between the plastic inner pipe and the connecting pipe.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional outside view of the present invention;

FIG. 2 is a schematic structural view of a control body of the present invention;

FIG. 3 is an outside structural view of a control valve and inlet and outlet pipes of the present invention;

FIG. 4 is a schematic cross-sectional structural view of inlet and outlet pipes and a control valve of the present invention;

FIG. 5 is a schematic structural view of an outlet assembly according to the present invention;

FIG. 6 is a schematic structural view of a plastic inner pipe combined with a spout piece of the present invention; and

FIG. 7 is a schematic structural view of a plastic inner pipe combined with a connecting pipe of the present invention.

### DETAILED DESCRIPTION OF THE INVENTION

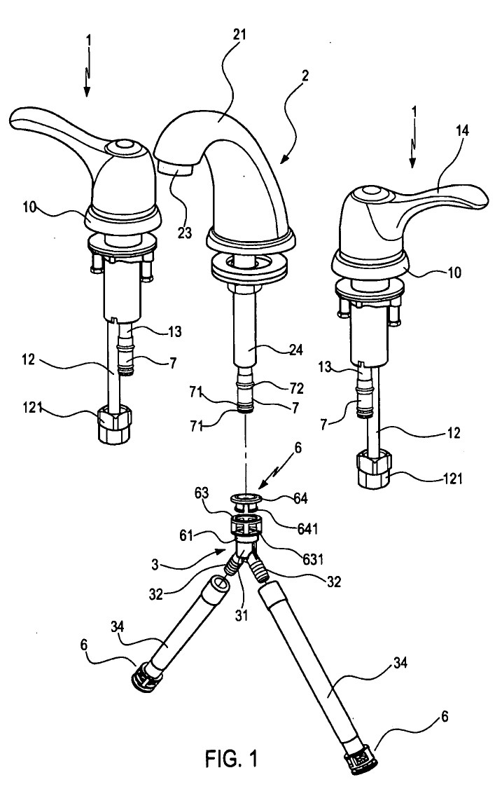

FIGS. 1 to 7 show a structure of a preferred embodiment of the present invention.

FIG. 1 is a three-dimensional exploded view of the present invention. A separable faucet according to this embodiment includes two control bodies 1, an outlet assembly 2, and a three-way pipe assembly 3. In practice, the two control bodies 1 are used to control water volumes of hot water and cold water respectively.

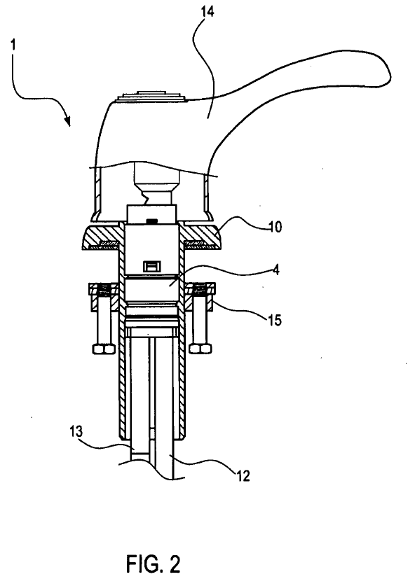

Each of the control bodies 1 has a base 10 respectively. A plastic control valve 4 (as shown in FIG. 2) is disposed in the base 10. The control valve 4 is connected to an inlet pipe 12 and an outlet pipe 13 respectively. One end of the inlet pipe 12 away from the control valve 11 is joined to a pipe joint 121 to facilitate the connection to a water source. A top of the control valve 4 is coupled to a handle 14 so that the control valve 4 is actuated by turning the handle 14 to adjust the discharged water volume. Additionally, the base 10 is used with a fixing component 15 to fix the base 10 onto equipment such as a wash basin.

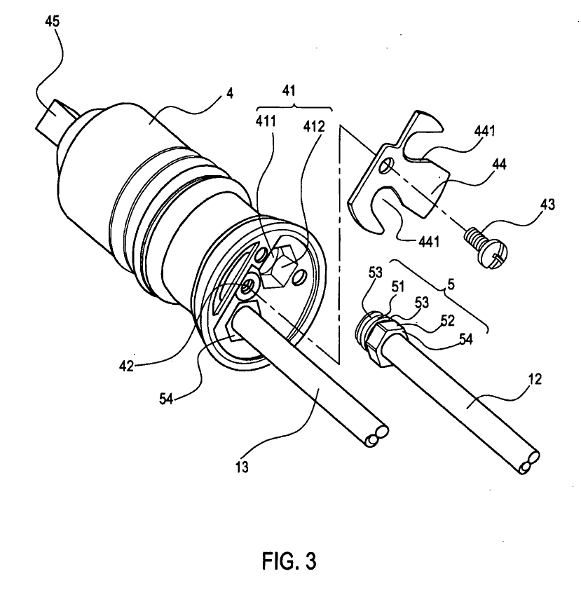

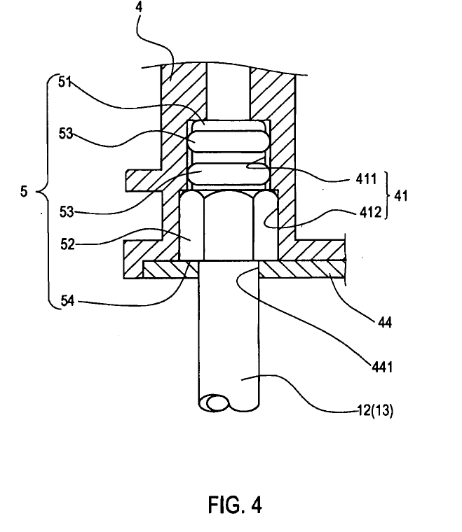

FIG. 3 is an outside structural view of a control valve and inlet and outlet pipes according to the present invention. FIG. 4 is a schematic cross-sectional structural view of inlet and outlet pipes combined with a control valve of the present invention.

The control valve 4 has joint holes 41 corresponding to the inlet pipe 12 and the outlet pipes 13 respectively. Each joint hole 41 extends out of the control valve 4 from inside. The joint hole 41 is formed of a round part 411 and a non-round part 412. A cross-section of the round part 411 is round, while a cross-section of the non-round part 412 is hexagon. The non-round part 412 is a section at the joint hole 41 passing out of the control valve 4.

The inlet pipe 12 and the outlet pipe 13 have a joint 5 respectively corresponding to the control valve 4. The joint 5 has a joint section 51 with a round cross-section and a non-round section 52 with a hexagon cross-section corresponding to the joint hole 41 of the control valve 4 respectively. Two sealing pieces 53 are sleeved on an outer edge of the joint section 51, so as to keep the sealing between the joint section 51 and the round part 411 of the joint hole 41. One end of the joint 5 abutting the inlet pipe or the outlet pipe has a stop face 54.

A screw hole 42 for securing a stop sheet 44 with a bolt 43 is disposed on a face where the joint holes 41 pass through the control valve 4. The stop sheet 44 is made of a metal material, and has notches 441 corresponding to the inlet pipe 12 and the outlet pipe 13 respectively. The notches 441 is only used for the inlet pipe 12 and the outlet pipe 13 to pass through, so that when the stop sheet 44 is fixed, the stop face 54 may be stopped at the joints 5, so as to fix the joints 5 in the joint holes 41.

In addition, an operation part 45 is provided at the top of the control valve 4 for fixing and connecting the handle 14.

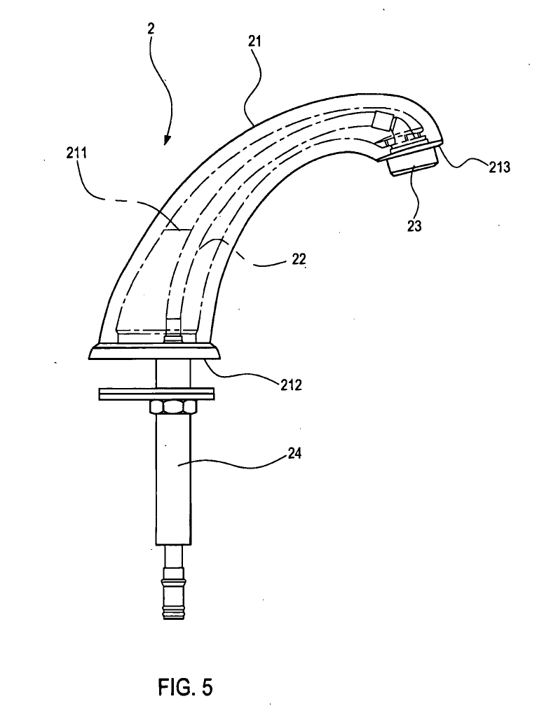

The outlet assembly 2 has a hollow shell body 21. The shell body 21 is made of a metal material. A soft plastic inner pipe 22 (as shown in FIG. 5) is disposed inside the shell body 21. One end of the plastic inner pipe 22 is connected to a spout piece 23, while the other end is connected to a connecting pipe 24.

The three-way pipe assembly 3 is made of a plastic material. The three-way pipe assembly 3 has a base 31 in the form of a three-way pipe. One end of the base 31 has a quick joint 6 for connecting the connecting pipe 24, the other two ends extend to form two joints 32, and a soft connecting pipe 34 is sleeved on each of the two joints 32 respectively. One end of each soft connecting pipe 34 away from each joint 32 is respectively disposed with a quick joint 6, which is coupled to the outlet pipes 13 of the two control bodies 1 respectively.

The quick joints 6 are made of a plastic material. Each of the quick joints 6 has a hollow body 61. The body 61 is used for the connection to a corresponding pipeline (for example, the base 31 or the soft connecting pipe 34). One end of the body 61 has an enlarged part 63, while a sliding sleeve 64 is disposed on the enlarged part 63. The sliding sleeve 64 has a plurality of clips 641 at an equal interval. The enlarged part 63 has openings 631 corresponding to the clips 641, such that each clip 641 may be positioned in the corresponding opening 631 by clipping.

One end of the connecting pipe 24 and the outlet pipes 13 fitted with the quick joints 6 is disposed with an insertion piece 7 respectively. Each insertion piece 7 is in a hollow pipe shape, and may be connected to the connecting pipe 24 or the outlet pipe 13. An outer edge of each insertion piece 7 is covered with two O-rings 71, so that after the insertion piece 7 is inserted into the body 61 of the quick joint 6, a sealing effect may be achieved. The insertion piece 7 has a major diameter part 72 corresponding to the clips 641 respectively, so that after the insertion piece 7 is inserted into and combined with the body 61, a positioning effect may be achieved by clipping the clips 641 on the major diameter part 72.

FIG. 5 is a schematic structural view of an outlet assembly of the present invention. The hollow shell body 21 of the outlet assembly 2 is made of a metal material. A chamber 211 is provided inside the shell body 21. An inlet end 212 and an outlet end 213 are provided at two ends of the chamber 211 respectively. The spout piece 23 is disposed at the outlet end 213, while the connecting pipe 24 is disposed at the inlet end 212. The plastic inner pipe 22 is then disposed in the chamber 211, and extends between the spout piece 23 and the connecting pipe 24.

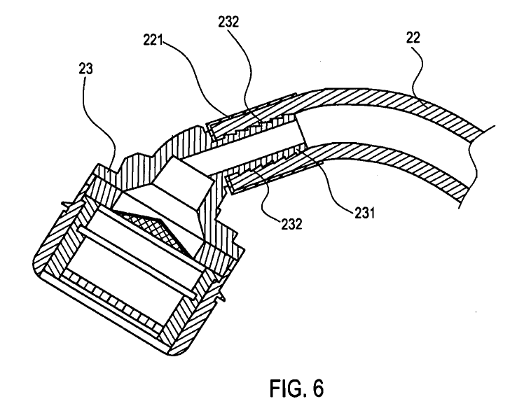

FIG. 6 is a schematic structural view of a plastic inner pipe combined with a spout piece of the present invention. The spout piece 23 is made of a plastic material. The internal structure of the spout piece 23 is the same as a conventional aerator, which will not be described here again. An engaging section 231 extends from one end of the spout piece 23 abutting the plastic inner pipe 22, and an outer edge of the engaging section 231 has a plurality of collar parts 232 in the shape of a barb. An outside diameter of each of the collar parts 232 is slightly larger than an inside diameter of the plastic inner pipe 22, so as to obtain a tight fitting when the plastic inner pipe 22 is sleeved in the engaging section 231. A metal cover 221 is sleeved on an outer edge of one end where the plastic inner pipe 22 abutting the engaging section 231, so that the expansion and deformation of the plastic inner pipe 22 may be limited by the metal cover 221, ensuring a usual tight combination between the plastic inner pipe 22 and the engaging section 231. In practice, the metal cover 221 is slightly larger than the plastic inner pipe 22. After the plastic inner pipe 22 and the engaging section 231 are tightly combined, the metal cover 221 is clamped with a tool and deforms, so that the metal cover 221 may tighten the plastic inner pipe 22 and the engaging section 231.

The technology that uses the metal cover to tightly combine the soft pipe piece and the rigid components may also be implemented between the soft connecting pipe and the joints and quick joints.

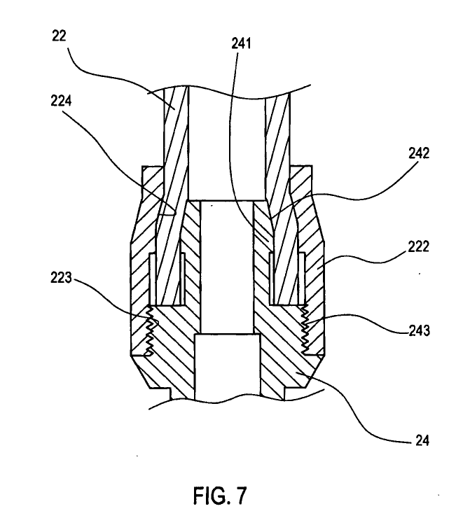

FIG. 7 is a schematic structural view of a plastic inner pipe combined with a connecting pipe of the present invention. The connecting pipe 24 is made of a plastic material. A joint section extends from one end of the connecting pipe 24 abutting the plastic inner pipe 22. A front end of the joint section 241 has a cone part 242, and the joint section 241 and the plastic inner pipe 22 are tightly fitted. An outer edge of one end of the plastic inner pipe 22 abutting the joint section 241 is covered by a metal cap 222. One end of the metal cap 222 has an internal thread part 223, while the connecting pipe 24 has an external thread part 243 correspondingly. The metal cap 222 has a minor diameter part 224 corresponding to the cone part 242 of the joint section 241, so that when the metal cap 222 is screwed on the connecting pipe 24, the plastic inner pipe 22 may be urged against the joint section 241 and the cone part 242 tightly by the minor diameter part 224, so as to achieve the tight fixation effect.

It is known from the above detailed description of the embodiment that, in the separable faucet of the present invention, components such as the inlet pipes 12, the control valves 4, the outlet pipes 13, the three-way pipe assembly 3, the quick joints 6, the connecting pipe 24, the plastic inner pipe 22, and the spout piece 23 are made of a plastic material, so that water may only flow in leadless plastic pipelines, so the objective of the nontoxic water source is achieved.

In particular, between the control valve 4 and the inlet pipe 12, and the outlet pipe 13 of the present invention, the stop face 54 of the joint 5 is stopped by the stop sheet 44 to fix the joint 5 in the joint hole 41. The fitting between the non-round section 52 of the joint 5 and the non-round part 412 of the joint hole 41 makes the joint 5 not rotate. The sealing pieces 53 are sleeved on the outer edge of the joint section 51 of the joint 5, so that the joint section 51 and the circular part 411 of the joint hole 41 are sealed. Thus, when water hammer effect and the like occur inside the control valve 4 and cause pressure changes, the pressure will only generate a pushing force on the joint 5, and the joint 5 is then stopped by the metal stop sheet 44. Therefore, the structure of the present invention may still keep the sealing between the joint 5 and the joint hole 41, so as to avoid loosening or leaking.

The stop sheet 44 of the present invention only needs to be secured by the bolt 43 to achieve the fixation effect. The screwdriver for spinning the bolt may easily reach into the small space at the bottom of the control valve to perform the assembly, which makes the assembly of the present invention more convenient and rapid.

Certainly, in addition to securing the stop sheet of the present invention by one bolt in the above embodiment, two bolts, or even three bolts may also be used to secure the stop sheet. At this time, the assembly is still quite convenient.

Moreover, between the plastic inner pipe 22 and the spout piece 23, the plastic inner pipe 22 and the engaging section 231 are tightened by the metal cover 221, so as to counteract the water pressure changes effectively, ensuring a tight combination between the plastic inner pipe 22 and the spout piece 23. Further, between the plastic inner pipe 22 and the connecting pipe 24, the plastic inner pipe 22 is urged against the joint section 241 and the cone part 242 tightly by the minor diameter part 224 with a force of the metal cap 222 screwed on the connecting pipe 24, thereby counteracting the water pressure changes effectively, so as to ensure a tight combination between the plastic inner pipe 22 and the connecting pipe 24.

Also, the three-way pipe assembly 3, the connecting pipe 24, and the outlet pipes 13 of the two control bodies 1 are connected by the quick joints 6, and thus, the assembly time is shortened greatly.

The description of the above embodiment is used to illustrate the present invention, but does not limit the present invention. Thus, variations of numbers or replacement of equivalent elements shall still fall within the scope of the present invention.

From the detailed illustration above, those skilled in the art may understand that the present invention may achieve the foregoing objectives. Therefore, the present invention conforms to the provisions of the Patent Law, and the applicant files a patent application for the present invention.

What is claimed is:

1. A plastic control valve for a faucet, comprising:
a control valve, made of a plastic material and connected to an inlet pipe and an outlet pipe, for controlling a water volume of the outlet pipe, wherein the control valve at least has a joint hole corresponding to the inlet pipe and a joint hole corresponding to the outlet pipe respectively, and each of the joint holes extends out of the control valve from inside;
two joints, connected to the inlet pipe and the outlet pipe respectively, wherein each of the joints has a joint section with a round cross-section corresponding to the joint hole, and the joint section is covered with more than one sealing piece to keep a tight sealing between the joint section and the joint hole, while one end of the joint abutting a pipe body has a stop face; and
a stop sheet, fixed at a face of the control valve having the joint holes, wherein the stop sheet has a notch corresponding to the inlet pipe and a notch corresponding to the outlet pipe, each of the notches is only used for the inlet pipe or the outlet pipe to pass through respectively, so that when the stop sheet is fixed at the control valve, the stop sheet is stopped at the stop faces of the joints to fix the joints in the joint holes.

2. The plastic control valve for a faucet according to claim 1, wherein one end of the joint hole further has a non-round part, while the joint has a non-round section corresponding to the non-round part, such that the inlet pipe does not rotate by fitting the non-round part and the non-round section.

3. The plastic control valve for a faucet according to claim 2, wherein the non-round part is located at a section where the joint hole passes through the control valve.

4. The plastic control valve for a faucet according to claim 2, wherein a cross-section of the non-round part and a cross-section of the non-round section are hexagons matching each other.

5. The plastic control valve for a faucet according to claim 1, wherein the stop sheet is made of a metal material.

6. The plastic control valve for a faucet according to claim 1, wherein the stop sheet is secured in a screw hole of the control valve by at least one bolt.

7. The plastic control valve for a faucet according to claim 1, wherein the control valve is disposed in a metal base, and one end of the control valve away from the inlet pipe and the outlet pipe is connected to a handle.

8. A separable faucet using a plastic control valve, comprising:
two control bodies, wherein each of the two control bodies has a base respectively, a plastic control valve is disposed in the base, the control valve is connected to an inlet pipe and an outlet pipe respectively, and the control valve is connected to a handle for adjusting a water volume; the control valve at least has a joint hole corresponding to the inlet pipe and a joint hole corresponding to the outlet pipe respectively, each of the joint holes extends out of the control valve from inside; the inlet pipe and the outlet pipe have a joint respectively corresponding to the control valve, the joint has a joint section with a round cross-section corresponding to the joint hole of the control valve, and the joint section is covered by one or more one sealing pieces to keep a tight sealing between the joint section and the joint hole, and one end of the joint abutting the pipe body has a stop face; a screw hole is disposed on a face that the control valve passes through the joint hole for securing a stop sheet with a bolt, the stop sheet has a notch corresponding to the inlet pipe and a notch corresponding to the outlet pipe, and each of the notches is only used for the inlet pipe or the outlet pipe to pass through, so that when the stop sheet is fixed at the control valve, the stop sheet is stopped at the stop faces of the joints to fix the joints in the joint holes;
an outlet assembly, having a hollow shell body, wherein the shell body is made of a metal material, and a soft plastic inner pipe is disposed in the shell body, one end of the plastic inner pipe is connected to a spout piece, an engaging section extends from one end of the spout piece abutting the plastic inner pipe, an outer edge of the engaging section has a plurality of collar parts in a shape of a barb, and an outside diameter of the collar parts is slightly larger than an inside diameter of the plastic inner pipe, and an outer edge of one end of the plastic inner pipe abutting the engaging section is covered by a metal cover, and an other end of the plastic inner pipe is connected to a connecting pipe, the connecting pipe is made of a plastic material, a joint section extends from one end of the connecting pipe abutting the plastic inner pipe, a front end of the joint section has a cone part, and the joint section and the plastic inner pipe are in tight fitting, an outer edge of one end of the plastic inner pipe abutting the joint section is covered by a metal cap, one end of the metal cap has an internal thread part, while the connecting pipe is disposed with an external thread part correspondingly, and a minor diameter part is disposed on the metal cap corresponding to the cone part of the joint section, so that the plastic inner pipe is urged against the joint section and the cone part tightly by the minor diameter part, and both of the spout piece and the connecting pipe protrude from the shell body; and
a three-way pipe assembly, made of a plastic material, and connected to the connecting pipe and the outlet pipes of the two control bodies respectively.

9. The separable faucet using a plastic control valve according to claim 8, wherein the three-way pipe assembly has a base in a form of a three-way pipe, one end of the base has a quick joint for connecting the connecting pipe, other two ends extend respectively to form two joints, and a soft connecting pipe is sleeved on each of the two joints respectively, and one end of each of the soft connecting pipes away from each of the joints is also disposed with a quick joint respectively, so as to be connected to the outlet pipes of the two control bodies respectively.

10. The separable faucet using a plastic control valve according to claim 9, wherein the quick joint is made of a plastic material, the quick joint has a hollow body, the body is used for connecting the three-way pipe assembly, one end of the body has an enlarged part, and a sliding sleeve is disposed on the enlarged part, the sliding sleeve has a plurality of clips at equal intervals, and the enlarged part has an opening corresponding to each of the clips, so that each of the clips may be positioned in each of the openings by clipping, one end of the connecting pipe and the outlet pipes fitted with the quick joint is respectively disposed with an insertion piece, each of the insertion pieces is in a hollow pipe shape and may be coupled to the connecting pipe or the outlet pipes, and two O-rings are sleeved on an outer edge of each of the insertion pieces, and each of the insertion pieces has a major diameter part corresponding to the clips respectively, so that the insertion piece is positioned by clipping the clips on the major diameter part.

11. The separable faucet using a plastic control valve according to claim 8, wherein a chamber is disposed in the hollow shell body of the outlet assembly, while an inlet end and an outlet end are disposed at two ends of the chamber respectively, the spout piece is disposed at the outlet end, while the connecting pipe is disposed at the inlet end, and the plastic inner pipe is then disposed in the chamber.

12. The separable faucet using a plastic control valve according to claim 8, wherein one end of the joint hole further has a non-round part, while the joint has a non-round section corresponding to the non-round part, so as to make the inlet pipe piece not rotate by fitting the non-round part and the non-round section.

13. The separable faucet using a plastic control valve according to claim 8, wherein the non-round part is located at a section where the joint hole passes through the control valve.

14. The separable faucet using a plastic control valve according to claim 8, wherein a cross-section of the non-round part and a cross-section of the non-round section are hexagons matching each other.

15. The separable faucet using a plastic control valve according to claim 8, wherein the stop sheet is made of a metal material.

16. The separable faucet using a plastic control valve according to claim 8, wherein the stop sheet is secured in the screw hole of the control valve by at least one bolt.
